(19) United States
(12) Patent Application Publication
(10) Pub. No.: US 2002/0169004 A1
(43) Pub. Date: Nov. 14, 2002

(54) Method of managing data stored in the memory of an SIM card of a mobile equipment

(75) Inventors: Herve Thil, Boulogne (FR); Stephane Augui, Paris (FR); Marc Tricoche, Sevrier (FR); Danbin Fu, Shanghai (CN)

Correspondence Address: Sughrue, SUGHRUE MION, PLLC, 2100 Pennsylvania Avenue, NW, Washington, DC, 20037-3213, US

(73) Assignee: ALCATEL

(21) Appl. No.: 10/142,890

(22) Filed: May 13, 2002

(30) Foreign Application Priority Data
May 14, 2001 (FR) 01 06 306

(51) Int. Cl. H04M 1/00

(52) U.S. Cl. 455/558

(57) ABSTRACT

In a method of managing data stored in the memory of an SIM card of a mobile equipment comprising a radio terminal equipped with the SIM card, at least one data structure is created as a function of the data, stored in a memory area of the terminal and indexed in accordance with the SIM card data.

### CROSS-REFERENCE TO RELATED APPLICATIONS

This application is based on French Patent Application No. 01 06 306 filed May 14, 2001, the disclosure of which is hereby incorporated by reference thereto in its entirety, and the priority of which is hereby claimed under 35 U.S.C. §119.

### BACKGROUND OF THE INVENTION

1. Field of the Invention

The invention relates to a method of managing data stored in the memory of a subscriber identity module (SIM) card of a mobile equipment, in particular a mobile telephone.

It relates more specifically to a method of managing data stored in the memory of an SIM card of a mobile equipment comprising a radio terminal equipped with an SIM card whereby at least one data structure is created as a function of said data.

2. Description of the Prior Art

Managing the data stored in the memory of an SIM card directly by means of a structure also stored in the memory of the SIM card is known in the art. However, because the capacity of this memory is limited, problems of memory space arise, necessitating, for example, compression of the data stored in the memory of the SIM card in order to augment the storage capacity thereof, as disclosed in the patent document GB 2 317 246.

The SIM card essentially contains basic information such as names and telephone numbers but cannot store additional data such as categories or families of numbers.

### SUMMARY OF THE INVENTION

The present invention solves the above problem and, to this end, the invention provides a method of managing data stored in the memory of an SIM card of a mobile equipment comprising a radio terminal equipped with the SIM card, in which method at least one data structure is created as a function of the data, stored in a memory area of the terminal and indexed in accordance with the SIM card data.

The above method has an advantage: it avoids duplicating data in the memory of the SIM card and therefore limits the memory size needed.

In a preferred embodiment, the data structure is managed in the memory of the terminal, organizes the data stored in the SIM card and includes a link to the stored identifiers of the SIM identity module and additional information for each of the stored identifiers.

The data structure advantageously includes identifiers indexed in accordance with the SIM card data and including the names in alphabetical order and their associated SIM items and other identifiers.

The above identifiers are preferably:

“New data item” item: code indicating the same SIM data item or a new data item;

“Family” item: identifier associated with the name: codes for private, business, other, unclassified;

“Last call” item: marking of the last number called with the card: codes for no, yes; and

“Category” item: identifier associated with the various numbers associated with the same name: codes for home, mobile, office, reserved.

A consistency verification program is advantageously executed if movement of the SIM card is detected.

Because the data structure is stored in the memory of the equipment, it is necessary to update it as a function of SIM card data modifications, for example if the SIM card is removed from its equipment and used in another equipment and its data is modified accordingly; the data structure must then be reindexed when it is reinstalled in the original equipment.

The verification program preferably reads all records of the SIM file and verifies if the item exists in the data structure, which is modified to agree with the SIM file.

To be more precise the verification program creates a temporary data structure adapted to replace the data structure when all the data items have been processed.

The temporary data structure is advantageously constructed by comparing its items with items of the data structure, initializing default items, reading “new data item” items, and comparing names and associated items.

The invention also provides a mobile equipment comprising a radio terminal equipped with an SIM card in a memory of which data is stored, which equipment is adapted:

to create at least one data structure relating to the SIM card data in a memory area of the radio terminal, and

to index the data structure in accordance with the SIM card data.

Other features of the invention will become apparent on reading the following description.

The invention is described in more detail hereinafter with the aid of figures showing embodiments of the invention by way of example.

### BRIEF DESCRIPTION OF THE DRAWINGS

FIG. 1 is a table representing the state of identifiers stored in an SIM card.

FIG. 2 is a table representing the state of identifiers stored in a data structure stored in the device.

FIG. 3 is a table representing the state of the SIM card identifiers after modification.

FIG. 4 is a table representing the state of identifiers stored in a temporary data structure stored in the device during the verification program.

### DETAILED DESCRIPTION OF THE PREFERRED EMBODIMENT

In the standard way, the data stored in the memory of an SIM card includes up to 255 data items comprising names and telephone numbers associated with the names, entered by the user in a random order.

The basic principle of the invention is to manage additional information in the memory of the terminal, for example a mobile telephone, and to execute a consistency verification program when an SIM card is inserted.

One or more data structures are managed in the memory and organize data stored in the SIM card. They include a link with identifiers stored in the SIM identity module and additional information for each of these identifiers.

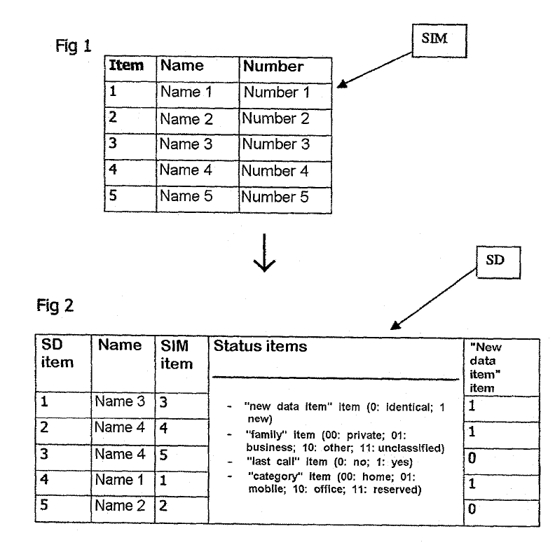

The identifiers stored in the SIM identity module take the form of the table shown in FIG. 1. They comprise a list of SIM items (data entry serial numbers), names and associated telephone numbers.

Initially, a first remanent data memory (RDM) data structure stored in the memory of the device can be qualified as a “family” structure, a family of calls consisting of three possible numbers for the same name. The characteristics of each family are as follows:

Activation identifier: Yes/No

This indicates if the structure must be used or not, i.e. if the mobile device is in a family management mode or not; the default value is No.

IMSI (identifier characterizing the SIM card).

Category identifier: 0 for private, 1 for business, 2 for others.

Melody identifier.

Call restriction: Yes/No (for example, receive only calls of one category).

This first data structure is specifically tied to the constitution of families.

A second RDM data structure SD stored in the memory of the device for managing SIM card data is constituted as a function of that data. Considering the data from table 1, the names i are here classified in alphabetical order with their associated SIM items. Diverse additional identifiers, here referred to as status items, are also associated with them. This can be represented schematically by the resulting data table shown in FIG. 2.

To be more precise, the identifiers are:

“New data item” item: 0 indicating the same SIM data item or 1 indicating a new data item;

“Family” item: identifier associated with the name: 00 for private, 01 for business, 10 for other, 11 unclassified;

“Last call” item: marking of the last number called with the card: 0 for no, 1 for yes; and

“Category” item: identifier associated with the various numbers associated with the same name: 00 for home, 01 for mobile, 10 for office, 11 for reserved.

One word of one byte corresponding to voice recognition is also stored.

Thus the data structure SD is created as a function of the SIM card data and stored in a memory area of the terminal.

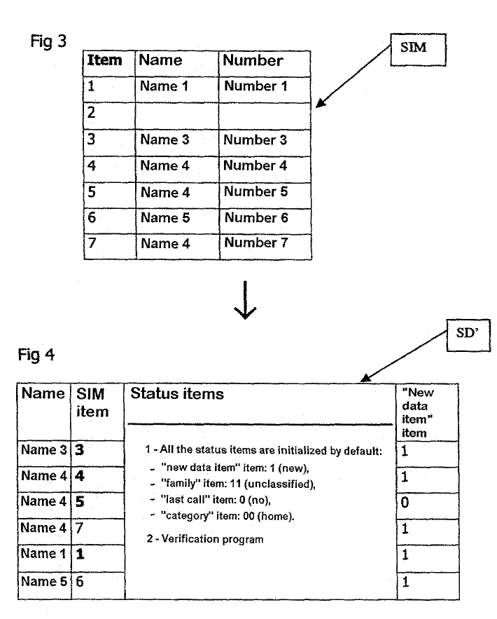

It must be possible to update the data structure stored in the memory of the terminal as a function of SIM card data modifications, for example if the SIM card is removed from the terminal to be used in another terminal and its data is modified accordingly, in which case data has to be added and other data deleted; the data structure must then be re-indexed when the card is reinstalled in the original terminal. FIG. 3 is a diagrammatic representation of this kind of SIM card modification.

In the case of simply moving the SIM card, the IMSI code of the card is that stored in the first data structure, and the category identifiers remain unchanged. If a data item has no family information, it is given a default value (unclassified); otherwise the data remains unchanged.

In the case of inserting a new SIM card with a different IMSI code, the information stored in the first structure remains unchanged apart from the IMSI code. If the user wishes to include a name in a family or to associate a plurality of numbers with a name, the information is re-indexed and the subscriber identity module becomes the main identity module.

According to the invention, a consistency verification program is executed if movement of the SIM card is detected.

The verification program reads all the records in the SIM file and verifies whether the entry exists in the data structure or not. Once this program has been executed, the data structure is modified to agree with the SIM file, i.e. all new records from the SIM identity module are added to the data structure and all records of the data structure not found in the SIM module are removed from the data structure.

To this end, a temporary data structure SD′ is created in the memory of the equipment, this structure being constructed as follows, and as shown in the FIG. 4 diagram:

The temporary structure SD′ repeats the corresponding SIM card items after the names are listed in alphabetical order;

All status items are initialized by default: “new data item” item: 1 corresponding to new data item, “family” item: 11 corresponding to unclassified, “last call” item: 0 corresponding to no, “category” item: 00 corresponding to home;

For each item of the structure SD′, the presence of the item in the list of the data structure SD is verified;

If the item is not present in the structure SD (FIG. 4: SIM item=7 and 6), nothing is done, i.e. the default values are retained (“new data item” item=1);

If the item is present in the structure SD (FIG. 4: SIM item=3, 4, 5, 1), the “new data item” item is tested:

if the item is equal to 1 in the structure SD (FIG. 4: SIM items=3, 4 and 1), then the other items are modified as follows:

“new data item” item: 1, “family” item: “family” item of the structure SD, “last call” item: “last call” item of the structure SD, “category” item: “category” item of the structure SD;

if the item is equal to 0 in the structure SD (FIG. 4: SIM item=5), then the name associated with the SIM item (FIG. 4: name 4) and the name associated with the preceding SIM item (FIG. 4: name 4) are read;

if the two names are identical and if the preceding item of the structure SD is identical to the preceding SIM item, then the status items of the temporary structure SD′ are replaced by the status items of the structure SD (FIG. 4: “new data item” item=0); and

if the two names are not identical or if the preceding item of the structure SD is not identical to the preceding SIM item, then nothing is done, i.e. the default values are retained.

When all the SIM items have been processed, the data structure SD is replaced by the data structure SD′ and the temporary structure SD′ is eliminated.

This method produces data items of 2 to 3 bytes in the data structure SD and the size of each data structure is less than or equal to 512 bytes.

There is claimed:

1. A method of managing data stored in the memory of an SIM card of a mobile equipment comprising a radio terminal equipped with the SIM card, in which method at least one data structure is created as a function of said data, stored in a memory area of said terminal and indexed in accordance with said SIM card data.

2. The method claimed in claim 1 wherein said data structure is managed in said memory of said terminal, organizes said data stored in said SIM card and includes a link to said stored identifiers of said SIM identity module and additional information for each of said stored identifiers.

3. The method claimed in claim 2 wherein said data structure includes identifiers indexed in accordance with said SIM card data and including said names in alphabetical order and their associated SIM items and other identifiers.

4. The method claimed in claim 3 wherein said identifiers are:
“New data item” item: code indicating the same SIM data item or a new data item;
“Family” item: identifier associated with the name: codes for private, business, other, unclassified;
“Last call” item: marking of the last number called with the card: codes for no, yes; and
“Category” item: identifier associated with the various numbers associated with the same name: codes for home, mobile, office, reserved.

5. The method claimed in claim 1 wherein a consistency verification program is executed if movement of said SIM card is detected.

6. The method claimed in claim 5 wherein said verification program reads all records of said SIM file and verifies if said item exists in said data structure, which is modified to agree with said SIM file.

7. The method claimed in claim 6 wherein said verification program creates a temporary data structure adapted to replace said data structure when all said data items have been processed.

8. The method claimed in claim 7 wherein said temporary data structure is constructed by comparing its items with items of said data structure, initializing default items, reading “new data item” items, and comparing names and associated items.

9. The method claimed in claim 8 wherein said temporary data structure includes the following steps and tests:
Said temporary structure repeats the corresponding SIM card items after said names are listed in alphabetical order;
All status items are initialized by default: “new data item” item: code corresponding to new data item, “family” item: code corresponding to unclassified, “last call” item: code corresponding to no, “category” item: code corresponding to home;
For each item of said structure, the presence of said item in the list of said data structure is verified;
If said item is not present in said structure, nothing is done, i.e. the default values are retained (“new data item” item=1);
If said item is present in said structure, said “new data item” item is tested:
if said item is equal to said code corresponding to a new data item in said structure, then the other items are modified as follows: “new data item” item: code corresponding to new data item, “family” item: “family” item of said structure, “last call” item: “last call” item of said structure, “category” item: “category” item of said structure;
if said item is equal to the code corresponding to the same data item in said structure, then the name associated with the SIM item and the name associated with the preceding SIM item are read;
if said two names are identical and if said preceding item of said structure is identical to said preceding SIM item, then said status items of said temporary structure are replaced by said status items of said structure; and
if said two names are not identical or if said preceding item of said structure is not identical to said preceding SIM item, then nothing is done, i.e. the default values are retained.

10. A mobile equipment comprising a radio terminal equipped with an SIM card in a memory of which data is stored, which equipment is adapted:
to create at least one data structure relating to said SIM card data in a memory area of said radio terminal, and
to index said data structure in accordance with said SIM card data.
